(19) United States
(12) Patent Application Publication
(10) Pub. No.: US 2005/0153243 A1
(43) Pub. Date: Jul. 14, 2005

(54) Ink-jet formation of flexographic printing plates

(75) Inventors: Michael Stephen Rundle, Danbury, CT (US); Douglas J. Edwards, North Salem, NY (US)

Correspondence Address: FAEGRE & BENSON;ATTN: PATENT DOCKING, 2200 WELLS FARGO CENTER, 90 SOUTH 7TH STREET, MINNEAPOLIS, MN, 55402-3901, US

(73) Assignee: Kodak Polychrome Graphics LLC, Norwalk, CT (US)

(21) Appl. No.: 11/032,505

(22) Filed: Jan. 10, 2005

Related U.S. Application Data
(60) Provisional application No. 60/535,311, filed on Jan. 9, 2004.

(51) Int. Cl. G03C 1/73

(52) U.S. Cl. 430/300

(57) ABSTRACT

The present invention provides a method for forming a flexographic printing plate that includes imagewise applying an image-forming material onto a substrate with an ink-jet printer to form a relief image, in which the image-forming material adheres to the surface of the substrate and resists deformation. The method of the present invention may further include treating the relief image.

The present application claims the benefit of pending U.S. provisional patent application, Ser. No. 60/535,311, entitled INK-JET FORMATION OF FLEXOGRAPHIC PRINTING PLATES, filed on Jan. 9, 2004.

### BACKGROUND

Relief printing plates are used in both flexographic and letterpress processes for printing on a variety of media, particularly for media which are soft and easily deformable, such as paper or plastic packaging materials, cardboard or other corrugated stock, film, foil, and laminates. Relief printing plates generally consist of raised image areas and depressed non-image areas. During printing, ink is transferred only from the raised image areas to the print media.

Historically, relief printing plates such as flexographic printing plates were formed from vulcanized rubber. Rubber was favored because it is resistant to harsh solvents, it has good ink transfer characteristics, high elasticity, and high compressibility. Rubber printing elements were originally made by vulcanizing the rubber material in a suitable mold. More recently, rubber printing elements have been made by direct laser engraving.

Relief printing plates are now generally made from photosensitive elements. The photosensitive elements that are used to make relief printing plates typically include a support layer, and one or more photosensitive layers comprising a photocurable composition including a polymer or prepolymer. Ideally, the support layer is made from a dimensionally stable material, such as polyester film or an aluminum sheet.

In making a relief printing plate from certain types of photosensitive elements, one side of the photosensitive layer is first exposed to an energy source (such as ultraviolet light) through the support to prepare a thin, uniform cured layer on the support side of the photosensitive layer. Then a masking device (such as a photographic negative) is placed over the photosensitive layer. The photosensitive element is then exposed to an energy source through the masking device, thereby causing exposed areas of the photosensitive layer to harden, or cure. Unexposed and uncured portions of the photosensitive layer are then removed by a developing process, leaving the cured portions, which define the relief printing surface.

Unfortunately, the above-described process may be relatively costly, time consuming and/or require the use of caustic chemicals for development. Thus, it would be beneficial to prepare a relief printing plate using a method that avoids at least some of the steps required in the conventional formation of relief printing plates.

The application of materials onto substrate surfaces by using ink-jet systems has been utilized in a wide variety of applications. In particular, ink-jet printing systems have been used in lithographic printing applications to imagewise apply oleophilic image forming materials onto the surface of a hydrophilic substrate. In this manner, the radiation exposure and development steps required in the formation of conventional lithographic plates may be eliminated.

Commercially available ink-jet printers use two general approaches to control the deposition of fluid materials onto substrates. Continuous ink-jet printers utilize electrostatic deflectors to selectively deflect fluid droplets between the substrate surface and a collection reservoir. In conventional drop-on-demand systems, fluid droplets are ejected from orifices directly to a position on the substrate surface by pressure created by, for example, a piezoelectric device, an acoustic device, or a resistive heater controlled in accordance with digital signals.

Each of these systems suffers from certain drawbacks. Although continuous ink-jet systems may eject droplets of a desirable size, such systems require the use of conductive ink materials to interact with the electrostatic deflectors. Conventional drop-on demand systems may be more cost efficient because ink droplets are not generated and ejected through the orifices of the print head unless they are needed to print pixels. However, such printing devices tend to produce larger droplets and are only able to eject a limited range of ink material. Furthermore, neither system is capable of precisely depositing suitably sized droplets of a wide range of materials, particularly materials having a relatively high viscosity when compared to conventional ink-jettable materials.

Likewise, conventional ink-jet materials used with these systems suffer from several drawbacks, including problems relating to a lack of suitable adhesion to substrates, poor image resolution, low durability, and/or short press life. One problem particular to the ink-jet formation of a relief image or pattern on a plate is that the oleophilic image must be raised above the substrate. Unfortunately, conventional ink-jet materials lack the characteristics (e.g. viscosity, curability) required to form a raised image.

Therefore, it would be beneficial to utilize an optimized combination of ink-jet systems and ink-jettable image-forming materials to provide an improved method of forming relief plates such as flexographic printing plates, as well as other topographical and/or textured patterns.

### SUMMARY OF THE INVENTION

In one embodiment, the present invention provides a method for forming a relief image or pattern on a substrate, in which an image-forming material is imagewise ink-jet applied onto a surface of a substrate and then optionally treated to form the relief image or pattern. In this embodiment, the image-forming material may be applied using an electrophoretic ink-jet system capable of stacking or layering respective droplets of the image forming material. Suitable image-forming materials include non-conductive particles that are dispersed in a carrier. The relief image may be formed by a single layer of a sufficiently viscous image-forming material. Alternatively, the relief image may be formed by continuously stacking or layering droplets of the image-forming material. The method may also optionally utilize one or more drying or curing steps (such as by ultraviolet or infrared radiation) during application of the image-forming material, and/or after formation of the relief image. After forming the desired relief image, the relief image may also be treated to increase the ink receptiveness of the relief image.

In another embodiment, the present invention provides a method for forming a relief image on a substrate, in which an image-forming material is imagewise ink-jet applied onto a surface of a substrate and then optionally treated to form the relief image.

In yet another embodiment, the present invention provides a method of forming a flexographic printing plate in which image-forming material is imagewise ink-jet applied onto a surface of a substrate and then optionally treated to form a relief image.

In still another embodiment, the present invention provides a method of forming a flexographic printing plate in which a flexible and dimensionally stable substrate comprising a polymeric material is provided and a sufficient amount of an image-forming material is imagewise ink-jet applied onto a surface of the substrate to form a relief image on the substrate surface. In this embodiment, the image-forming material is capable of adhering to the substrate and of forming the relief image. The image-forming material of this embodiment is ink-jet applied using an electrophoretic ink-jet system capable of depositing droplets of the image-forming material onto the substrate to form the relief image. The method may further include treating the ink-jet applied image-forming material to form an oleophilic relief image on the substrate.

In an alternative embodiment, the present invention provides a method of forming a flexographic printing plate that includes providing a flexible film and an image-forming material including a carrier and marker particles (also referred to as solid particles). The method further includes imagewise applying the image-forming material onto a surface of the film using an ink-jet system to form a relief image. In this embodiment, the ink-jet system is capable of concentrating the solid particles to form a concentrated image-forming material having a solids content higher than about 2.4 wt % and depositing one or more layers of the concentrated image-forming material onto the surface of the substrate to form an image. Alternatively, the ink-jet system is capable of concentrating the solid particles to form a concentrated image-forming material having a solids content higher than about 5.5 wt % and depositing one or more layers of the concentrated image-forming material onto the surface of the substrate to form an image. The image then adheres to the surface of the film and resists dimensional deformation after deposition on the surface of the film such that a relief image for flexographic printing is formed. This embodiment may further include the steps of treating the relief image during or after formation of the relief image. The treatments may include drying or curing the relief image or exposing the relief image to a conditioner.

In a further embodiment, the present invention provides a method of forming a mask on a flexographic printing plate precursor that includes a substrate and a photosensitive layer. A mask material is imagewise ink-jet applied onto the photosensitive layer and then dried or cured to form a mask on the flexographic printing plate precursor. The precursor may be exposed to radiation through the mask and then developed in a suitable developer liquid to remove portions of the photopolymerizable layer that were not exposed to the radiation.

In yet a further embodiment, the present invention provides a method for forming a printing plate precursor in which one surface of a substrate is coated with a photosensitive layer, which is then dried or cured. A mask material is imagewise ink jet applied onto the photosensitive layer and then dried or cured to form a flexographic printing plate precursor.

### BRIEF DESCRIPTION OF THE SEVERAL VIEWS OF THE DRAWINGS

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

FIG. 1 illustrates, diagrammatically, a cell of a printhead in section, together with flow vectors;

FIGS. 2, 2A, 3 & 3A illustrate the same cell in greater detail, in section;

FIGS. 4A & 4B illustrate waveforms for the voltages applied to the electrode in the cell; and

FIG. 5 is a block diagram of an incipient drive control;

FIG. 6 is a partial perspective view of a portion of a second printhead incorporating ejection apparatus according to the present invention;

FIG. 7 is a view similar to FIG. 6 showing further and alternative features of the ejection apparatus; and

FIGS. 8 and 9 are partial sectional views through a cell of FIG. 6 and a modification thereof.

### DETAILED DESCRIPTION

In one embodiment, the present invention provides methods for forming a relief image or pattern (collectively referred to herein as a “relief image”) on a substrate, which may be suitable for use in forming relief images for use in flexographic printing plates. As used herein, the term “relief image” refers to relief images such as those used in flexographic and letterpress applications, as well as other images or patterns that are formed on a substrate that have a significant topography or texture. To form the desired relief image, an optimized ink-jet system imagewise ejects an image-forming material directly onto a substrate. The image-forming material may then be further treated to form a relief image.

Suitable substrates for use with embodiments of the present invention include conventional substrates commonly used in conventional relief plate applications. Suitable substrates are generally strong, dimensionally stable, and flexible. Suitable substrates should resist dimensional change under conditions of use so that the same mask or relief printing plate, when used at different times or in different environments, does not cause registration problems. This is particularly important when the substrate is to be used in printing processes that involve multiple color overlays (such as yellow, cyan, magenta, and black) typically used in full color printing processes. Specific substrate materials include polymeric films (e.g. polyethylene terephthalate, polystyrene, polyethylene, polypropylene, polycarbonate, polyamide and fluoropolymers), ceramics, metals, cardboard or papers, or a laminate, or other combinations of any of these materials. Suitable metal substrates include, for example, aluminum, zinc, titanium, and alloys thereof.

In an embodiment of the present invention, it may be desirable that the substrate be sufficiently transparent to ultraviolet and/or infrared radiation. Thus, the substrate may be a transparent, polymeric film. An example of a transparent, polymeric film is a polyethylene terephthalate sheet (PET) is about 20 μm to 200 μm thick. For example, a PET sheet sold under the name MELINEX by DuPont Teijin Films (Hopewell, Va.), such as MELINEX 574, is suitable.

Aluminum substrates may be subjected to one or more surface treatments to improve the surface properties of the substrate. Substrate treatments that may be suitable for embodiments of the present invention are provided in Table 1 below:

TABLE 1

| | | INTERLAYER |
|---|---|---|
| SUBSTRATE | SURFACE TREATMENT | TREATMENT |
| AA | Quartz Grained and | None |
| | Anodized | |
| EG-PVPA | Electrograined and | Polyvinyl phosphoric acid |
| | Anodized | |
| PF | Electrograined and | Sodium dihydrogen |
| | Anodized | phosphate/Sodium fluoride |
| G20 | Electrograined and | Vinylphosphonic |
| | Anodized | acid/acrylamide copolymer |
| EG-Sil | Electrograined and | Sodium Silicate |
| | Anodized | |
| DS-Sil | Chemically Grained and | Sodium Silicate |
| | Anodized | |
| PG-Sil | Pumice Grained and | Sodium Silicate |
| | Anodized | |
| CHB-Sil | Chemically Grained, | Sodium Silicate |
| | Anodized and Silicated | |

In Table 1 above, the abbreviation “AA” refers to “as anodized.” An aluminum surface is quartz grained and then anodized using DC current of about 8 A/cm² for 30 seconds in a H₂SO₄ solution (280 g/liter) at 30° C.

“EG” means “electrolytic graining.” The aluminum surface is first degreased, etched and subjected to a desmut step (removal of reaction products of aluminum and the etchant). The plate is then electrolytically grained using an AC current of 30-60 A/cm² in a HCl solution (10 g/liter) for 30 seconds at 25° C., followed by a post-etching alkaline wash and a desmut step. The grained plate is then anodized using DC current of about 8 A/cm² for 30 seconds in a H₂SO₄ solution (280 g/liter) at 30° C.

“PVPA” is a polyvinylphosphonic acid. A plate is immersed in a PVPA solution and then washed with deionized water and dried at room temperature.

“PF” means that the substrate has a phosphate fluoride interlayer. The process solution contains sodium dihydrogen phosphate and sodium fluoride. An anodized substrate is treated in the solution at 70° C. for a dwell time of 60 seconds, followed by a water rinse and drying. The sodium dihydrogen phosphate and sodium fluoride are deposited as a layer to provide a surface coverage of about 500 mg/m².

“G20” is a printing plate substrate described in U.S. Pat. No. 5,368,974, which is incorporated herein by reference.

“Sil” means that an anodized plate is immersed in a sodium silicate solution to coat it with an interlayer. The coated plate is then rinsed with deionized water and dried at room temperature.

“DS” means “double sided smooth.” As aluminum oxide plate is degreased, etched or chemically grained, and subjected to a desmut step. The smooth plate is then anodized.

“PG” means “pumice grained.” The surface of an aluminum substrate is degreased, etched and subjected to a desmut step. The plate is then mechanically grained by subjecting it to a 30% pumice slurry at 30° C., followed by a post-etching step and desmut step. The grained plate is then anodized using DC current of about 8 A/cm² for 30 seconds in a H₂SO₄ solution (280 g/liter) at 30° C. The anodized plate is then coated with an interlayer of, for example, sodium silicate.

“CHB” means chemical graining in a basic solution. After an aluminum substrate is subjected to a matte finishing process, a solution of 50 to 100 g/liter NaOH is used during graining at 50° C. to 70° C. for 1 minute. The grained plate is then anodized using DC current of about 8 A/cm² for 30 seconds in a H₂SO₄ solution (280 g/liter) at 30° C. The anodized plate is then coated with a silicated interlayer.

Other substrates (e.g. film) may also be surface-treated to modify its wettability and adhesion to subsequently applied coatings and/or materials such as the image forming materials of the present invention. Such surface treatments include corona discharge treatment and/or the application of subbing layers or release layers.

Suitable ink-jet systems for use in embodiments of the present invention should be able to successfully eject a wide range of image-forming materials to form the desired relief image. More particularly, suitable ink-jet systems should be able to precisely and accurately deposit suitably sized droplets of image-forming materials, which have a significantly higher viscosity than conventional ink materials, in order to form relief images. Specifically, suitable ink-jet systems may incorporate one or more of the features reported in U.S. Pat. Nos. 5,992,756, 6,217,154, 6,247,797 and 6,409,313 each to Newcombe et al., 6,019,455 to Taylor et al., 6,260,954 to Lima-Marques, 6,302,525 to Janse Van Rensburg et al. and 6,394,583 to Mace et al., each of which is incorporated herein by reference.

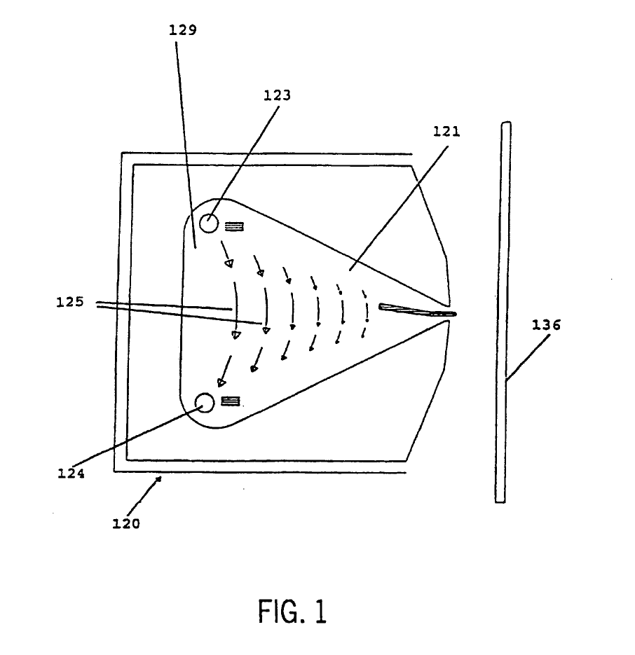

A key aspect of the above ink-jet system technology is reported in U.S. Pat. No. 5,992,756 patent (the '756 patent), which reports a drop-on-demand ink-jet system utilizing electrophoretic technology. More specifically, referring to the FIGS. 1-9, the printhead utilizes concentration cells 120 of generally triangular internal shape, providing a cavity 121 to which an image-forming material such as an ink 122 is supplied under pressure (for example from a pump—not shown) through an inlet 123 and defining an ejection location for the solids in the carrier. To enable continuous operation, an outlet 124 is provided so that a flow vector distribution, as indicated in FIG. 1 by the arrows 125, is produced in operation. The cell shown has external dimensions of 10 mm width, 13.3 mm overall length and thickness 6 mm.

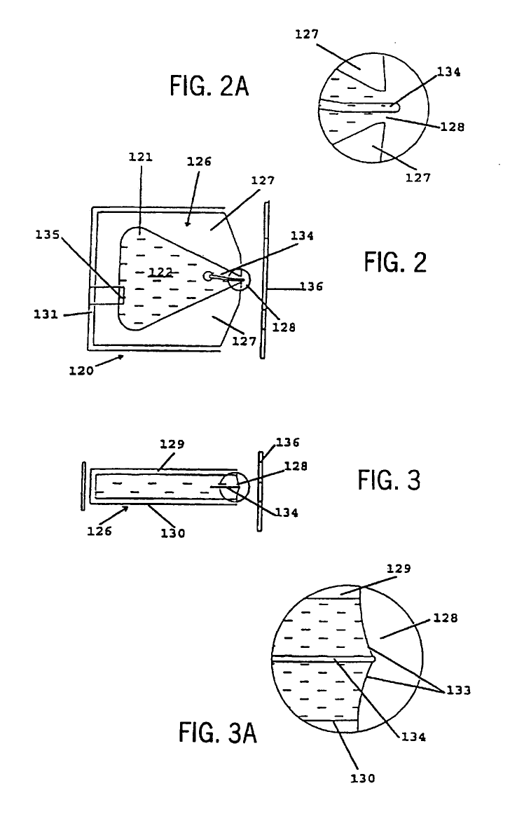

The cell 120 comprises a PEEK (Poly Ether Ether Ketone) housing 126 which, in section as seen in FIGS. 2 & 3, has opposed generally wedge-shaped cheeks 127 which define the triangular shape of the cavity 121 and an aperture 128. The aperture 128 has a width of about 100 microns. FIGS. 2A & 3A illustrate, respectively, details of the aperture 128 and the ink meniscus 133 which is formed there in use. At each wide face, the cell is closed by plastics side walls 129, 130 which form part of the housing 126. The housing 126 may form part of a larger assembly providing support fixings and the like. These are not shown as they do not affect the principle of operation and are unnecessary in the present context.

Disposed around the outside of the cell 120 is a thin plate-like electrode 131. The electrode 131 surrounds the narrower side walls provided by the cheeks 127 and the base portion of the plastic housing 126 and has a tab or tongue 135 which projects into the cavity 121 in order to make contact with the ink 122. The electrode 131 (known as the electrophoretic electrode) and the cheeks 127 are shaped such that, in use, a component of electric field vectors E in the ink directs the solids such as insoluble ink particles away from the walls of the cell. In other words, (E)*(n)>0 around most of the perimeter of the ink cell 120, where “E” is the electric field vector and “n” is the surface normal, measured from the wall into the ink. This ensures that the insoluble ink particles are not adsorbed on the perimeter of the cell which would otherwise modify the electric field of the cell.

Within the aperture 128, there is disposed an ejection electrode 134 (in an alternative embodiment, for multiple pixel printing, plural electrodes 134′ may be provided in an array). The electrode 134 is electroformed nickel of 15 microns thickness with a cross-section typical of electroformed parts. One face of the electrode is flat and the other face is slightly curved. Solid particles such as ink particles are ejected onto a substrate 136 in use.

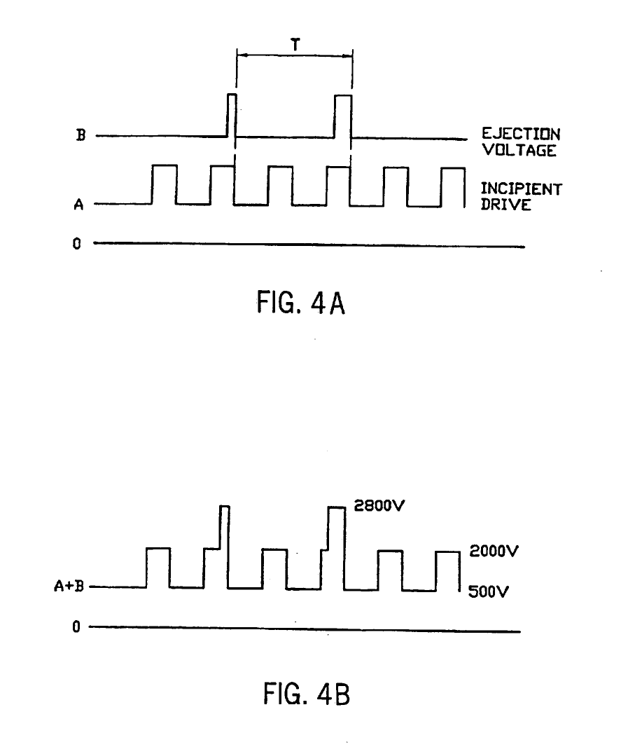

FIG. 4A illustrates, with respect to ground, the oscillating voltage applied to the electrode 134 (waveform A) and the ejection voltage (waveform B) superimposed on the oscillating voltage. It can be seen that the voltages are timed such that the falling edge of an ejection voltage pulse coincides with the falling edge of the incipient drive pulse or oscillating voltage and that the length of an ejection pulse is smaller than that of the oscillating voltage pulse. The resulting voltage on the ejection electrode 134 is shown in FIG. 4B with suitable values shown attached to the voltage pulses. By varying the length of the ejection voltage pulses it is possible to achieve a gray scale effect in printing.

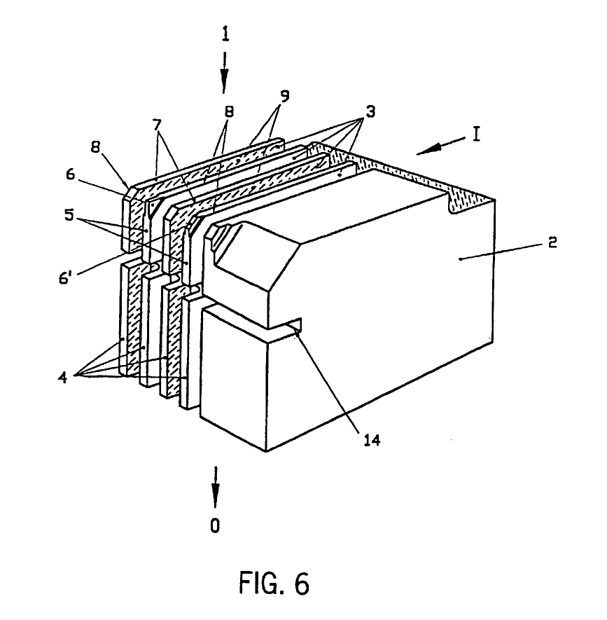

A further example is illustrated in FIGS. 6 to 9. FIG. 6 illustrates part of an array-type printhead 1, the printhead comprising a body 2 of a dielectric material such as a synthetic plastics material or a ceramic. A series of grooves 3 are machined in the body 2, leaving interposing plate-like lands 4. The grooves 3 are each provided with an ink inlet and ink outlet (not shown, but indicated by arrows I & O) disposed at opposite ends of the grooves 3 so that ink carrying a solid material, which is to be ejected, may be passed into the grooves and depleted carrier fluid passed out.

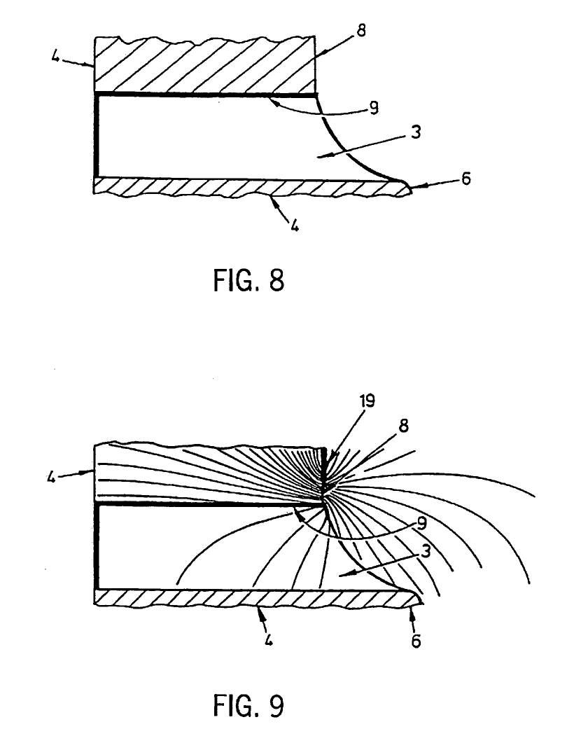

As illustrated in FIG. 6, each pair of adjacent grooves 3 define a cell 5, the plate-like land or separator 4 between the pairs of grooves 3 defining an ejection location for the solid material and having an ejection upstand 6, 6′. In FIG. 6, two cells 5 are shown, the left-hand cell 5 having an ejection upstand 6 which is of generally triangular shape and the right-hand cell 5 having a truncated ejection upstand. Each of the cells 5 is separated by a cell separator 7 formed by one of the plate-like lands 4 and the corner of each separator 7 is shaped or chamfered as shown so as to provide a surface 8 to allow the ejection upstand to project outwardly of the cell beyond the exterior of the cell as defined by the chamfered surfaces 8. A truncated ejection upstand 6′ is used in the end cell 5 to reduce end effects resulting from the electric fields which in turn result from voltages applied to ejection electrodes 9 provided as metallized surfaces on the faces of the plate-like lands 4 facing the ejection upstand 6, 6′ (i.e. the inner faces of each cell separator). As can be seen from FIG. 8, the ejection electrodes 9 extend over the side faces of the lands 4 and the bottom surfaces 10 of the grooves 3. The precise extent of the ejection electrodes 9 will depend upon the particular design and purpose of the printer.

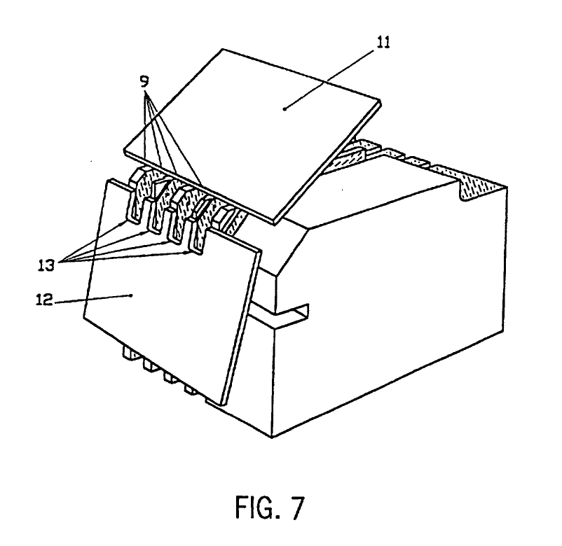

FIG. 7 illustrates two alternative forms for side covers of the printer head, the first being a simple straight-edged cover 11 which closes the sides of the grooves 3 along the straight line as indicated in the top part of FIG. 7. A second type of cover 12 is shown on the lower part of the figure, the cover still closing the grooves 3 but having a series of edge slots 13 which are aligned with the grooves. This type of cover construction may be used to enhance definition of the position of the fluid meniscus which is formed in use and the covers, of whatever form, can be used to provide surfaces onto which the ejection electrode and/or secondary or additional electrodes can be formed to enhance the ejection process. FIG. 7 also illustrates an alternative form of the ejection electrode 9, which comprises an additional metallized surface on the face of the land 4 which supports the ejection upstand 6, 6′. This may help with charge injection and may improve the forward component of the electric field.

FIG. 8 illustrates a partial sectional view through one side of the cells 5 of FIG. 6 and FIG. 9 an equivalent sectional view but indicating the presence of a secondary electrode 19 on the chamfered face 8. The same or similar voltages waveforms can be applied to the ejection electrode of this second printhead as in the case of the first printhead shown in FIGS. 1 to 3A.

In either of the exemplified printheads, the oscillating voltage may be applied to different electrodes at the ejection location. For example, while the specific description above has described application to the ejection electrode 134, the voltage may be applied to a bias or secondary electrode of the type disclosed in British Patent Application 9601226.5, which is incorporated herein by reference.

Advantageously, the ink-jet systems reported above are able to accurately eject suitably sized droplets of relatively high viscosity image-forming materials in order to form relief images on suitable substrates. More particularly, the reported systems may be able to “stack” or “layer” drops relative to one another more precisely than conventional ink-jet systems. In one embodiment, the term “relatively high viscosity” may refer to a viscosity high enough to form a droplet of the image-forming material on the substrate surface that resists spreading (e.g. low spreadability) or distortion of its dimensions as deposited. The droplet of image-forming material may further have sufficient adhesion characteristics and surface tension to resist spreading or dimensional distortion such that the relief image may be formed. In certain embodiments, the viscosity of the droplet of the image-forming material may also be higher than the viscosity of the image-forming material before it is applied to the surface of the substrate, in part because solid particles in the image-forming material are concentrated by the ink-jet system previously described.

Suitable image-forming materials for ink-jet application onto the substrate should be compatible with the ink-jet systems reported herein. Additionally, the image-forming materials should be able to adhere to the substrate and to form the desired relief image. In particular, suitable image-forming materials should have a sufficient viscosity, adhesion characteristics and surface tension to provide for the application of multiple “layers” or “droplets” of the image forming material in order to “form” or “grow” a raised topographical image such as a relief image. The image-forming material may also have a suitable surface tension to be deposited in a suitable droplet size to form relief images having satisfactory resolution. If the relief image is to be employed in a printing application it may also be desirable for the image-forming material to possess oleophilic properties upon application onto the substrate. It may be additionally desirable that the image-forming materials be suitably durable to withstand the pressroom environment after application to the substrate.

In one embodiment, the image-forming materials suitable for use with the ink-jet systems reported above generally include a carrier that contains solid particles dispersed or dissolved in the carrier. In another embodiment, the solid particles are insoluble in the carrier, and may also have a dielectric constant that is different than that of the carrier. Thus, when an electric field is applied across the system, the field induces dipoles in the solid particles on which the non-uniform field acts to move the solid particles in direction of increasing field strength. This results in the solid particles concentrating near the ejection orifice for deposition on the substrate. Advantageously, when used in conjunction with the ink-jet systems previously described, the concentration of solid particles in the carrier may be significantly higher than when used with conventional ink-jet systems. This results in a higher viscosity image-forming material that may exhibit lower-bleeding and wicking characteristics than conventional ink-jettable materials. Thus, in one embodiment of the present invention, the viscosity of the droplets of the image-forming material may be higher than about 2-15 mPa.s, where about 2-15 mPa.s is a representative viscosity range for the image-forming material before it is concentrated. Additionally, in an embodiment of the present invention, concentration of the solid particles may result in the solids content of the image-forming material applied to the substrate surface being higher than the solids content of the image-forming material before application to the substrate surface. Thus, for example, the relief image may be formed by image-forming material having a solids content greater than about 2.4 wt %, where 2.4 wt % is a typical solids content for the image-forming material before being concentrated by the ink-jet system previously described. Alternatively, the relief image may be formed by image-forming material having a solids content greater than about 5.5 wt %.

Examples of suitable solid particles include marker particle materials such as polymeric materials, metals, ceramics, conventional pigments and dyes, as well as combinations of these materials. Examples of suitable polymeric materials include epoxy resins such as bisphenol A epoxy, novolac epoxy and cycloaliphatic epoxy; acrylic resins such as polymers and copolymers of acrylic acid and esters thereof, polymers and copolymers of methacrylic acid and esters thereof; vinyl resins such as polymers and copolymers including vinyl acetate, vinyl chloride, vinyl alcohol and vinyl butyral; alkyd resins such as oil, phenolic and rosin modified alkyds and finally modified rosin esters such as dimerised pentaerythritol rosin ester. These polymers may be dyed or include pigments dispersed therewith. Suitable particles may be curable when exposed to ultraviolet or infrared radiation.

Suitable metal powders, such as copper, zinc or aluminum powders, as well as alloys thereof may be surface treated with a material having high electrical resistivity in order to function suitably with the ink-jet systems previously described. Suitable materials having a high electrical resistivity include polymers, waxes, organic pigments and dyes. Suitable polymers for this treatment include epoxy resins, acrylic resins, acrylic acid polymers and vinyl resins. These materials may be dissolved in a non-conductive solvent and then coated onto the metal powders as reported in U.S. Pat. No. 6,117,225 to Nicholls, which is incorporated herein by reference.

Suitable carriers for use in certain embodiments may include aqueous carriers, organic carriers and mixtures of aqueous and organic liquids. Examples of suitable aqueous carriers include solutions of 100 v/v % water and mixtures of water and water-miscible organic liquids such as alcohols.

The image-forming materials may also include additional polymeric binders that are soluble or partially soluble in the carrier. Examples of suitable binders may include epoxy resins, modified epoxy resins, polyester resins, novolak resins, cellulosic materials, hydroxypropylcellulose, hydroxyethylcellulose, hydroxypropylmethylcellulose, carboxymethylcellulose, copolymers of vinylidene chloride and acrylonitrile, acrylic acid resins, polyvinyl resins, silicone resins, polyamide resins, vinyl alcohol resins, resol resins, acetal resins, polyacrylonitrile resins, formaldehyde resins, polycarbonate resins, polyimide resins, polyethyleneimine, poly(ethyloxazoline), gelatin, starches, dextrin, amylogen, gum arabic, agar, algin, carrageenan, fucoidan, laminaran, corn hull gum, gum ghatti, karaya gum, locust bean gum, pectin, guar gum and copolymers or derivatives thereof.

Additional examples of polymeric binders may include epoxy resins produced by the condensation of epichlorohydrin and Bisphenol A or F, epoxy novolak resins, rubber modified epoxy resins, Bisphenol A based polyester resins, epoxydized o-cresylic novolaks, urethane modified epoxy resins, phosphate modified Bisphenol A epoxy resins, cellulose esters, copolymers of vinylidene chloride and acrylonitrile, poly(meth)acrylates, polyvinyl chloride, silicone resins, polyesters containing hydroxy or carboxy groups, polyamides comprising amino groups or carboxy groups, polymers and copolymers of vinyl alcohol, polyvinylimidazole, polyvinylpyrrolidone, polymers and copolymers of vinylphenol, acrylamide, methylol acrylamide, methylol methacrylamide, polyacrylic acid, methacrylic acid, hydroyethyl acrylate, hydroxethyl methacrylate, maleic anhydride/vinyl methyl ether copolymers, novolak resin, resol resin, polyvinyl phenol resin, copolymers of acrylic acid, polyacetal, poly(methyl methacrylate), polymethacrylic acid, polyacrylonitrile, cellulose acetate, cellulose acetate butyrate, cellulose acetate propionate, melamine formaldehyde resins, polycarbonates, polyimides and urea formaldehyde resins.

Optionally, the image-forming layer may also include a surfactant or other dispersing agent. A wide variety of surfactants or other dispersing agents may be used. Examples of suitable dispersing agents include cationic, anionic, amphoteric and non-ionic surfactants. Specific examples include perfluoroalkyl, alkylphenyl, or polysiloxane surfactants. Suitable polysiloxane surfactants include polyether/polysiloxane copolymer, alkyl-aryl modified methyl-polysiloxane and acylated polysiloxane. Other suitable surfactants include sorbitan tristearate, sorbitan monopalmitate, sorbitan triolate, mono glyceride stearate, polyoxyethylene nonylphenyl ether, alkyl di (aminoethyl) glycine, alkyl polyaminoethylglycine hydrochloride, 2-alkyl-n-carboxyethyl-N-hydroxyethyl imidazolinium betaine, and N-tetradecyl-N, N-substituted betaine.

Additional surfactants may include alkylated surfactants, fluorosurfactants and siliconated surfactants. Examples of these surfactants include sodium dodecylsulfate, isopropylamine salts of an alkylarylsulfonate, sodium dioctyl succinate, sodium methyl cocoyl taurate, dodecylbenzene sulfonate, alkyl ether phosphoric acid, N-dodecylamine, dicocoamine, 1-aminoethyl-2-alkylimidazoline, 1-hydroxyethyl-2-alkylimidazoline, cocoalkyl trimethyl quaternary ammonium chloride, polyethylene triacetyl ether phosphate and the like.

Examples of suitable fluorosurfactants also include ZONYL FSD, ZONYL FSA, ZONYL FSP, ZONYL FSJ, ZONYL FS-62, ZONYL FSK, ZONYL FSO, ZONYL FS-300, ZONYL FSN, and OLIN 10G, all of which are commercially available from E.I. Du Pont De Nemours & Co. Additional examples of suitable fluorosurfactants include FLUORAD FC-135, FLUORAD FC-129, FLUORAD FC-120, FLUORAD FC-100, FLUORAD FC-170C FLOURAD FC431 and FLUORAD FC-171, all of which are commercially available from 3M, St. Paul, Minn. Suitable fluorocarbon surfactants such as the fluorinated polymers described in U.S. Pat. No. 5,380,644 to Yonkoski, et al are also available, for example, as NOVEC fluorosurfactant FC 4432 from 3M.

Further examples of suitable surfactants include polyether modified poly-dimethyl-siloxane, silicone glycol, polyether modified dimethyl-polysiloxane copolymer, and polyether-polyester modified hydroxy functional polydimethyl-siloxane.

In one embodiment, a suitable quantity of surfactant may be in the range of about 0.05 to 5 wt %, or alternatively in the range of about 1 to 2 wt %.

Optionally, the image-forming material may also include humectants, biocides, viscosity builders, colorants (e.g. a dye or pigment), pH adjusters, drying agents, defoamers, plasticizers, UV absorbers, IR absorbers, fillers or combinations thereof. Suitable humectants may prevent the inkjet nozzles described below from clogging and/or drying out. Examples of suitable humectants include ethylene glycol and sorbitol. Suitable biocides include Proxel GXL (supplied by Zeneca Corporation, London, England), Kathion X L (supplied by Rohm and Haas, Philadelphia, Pa.), Triclosan (supplied by Ciba Specialty Chemicals, Tarrytown, N.Y.). An example of a suitable viscosity builder includes polyethylene glycol. Such optional image-forming materials will be familiar to those of skill in art.

Other suitable image-forming materials may be available from Tonejet Corporation Pty, Ltd., Eastwood, Australia.

Examples of suitable image-forming materials are provided in Tables 2a-d.

TABLE 2a

| Component | Amount (grams) |
|---|---|
| Tintacarb 300 | 25 |
| Araldite GT 6084 | 25 |
| FOA-2 | 5 |
| 6% Nuxtra Zirconium | 25 |
| DC 344 | 420 |

TABLE 2b

| Component | Amount (grams) |
|---|---|
| Irgalite Blue LGLD | 20 |
| Araldite GT 6084 | 200 |
| 6% Nuxtra Zirconium | 2 |
| DC 200 Fluid 1 cs | 500 |

TABLE 2c

| Component | Amount (grams) |
|---|---|
| Irgalite Blue LGLD | 0.5 |
| Araldite GT 6084 | 2.0 |
| 6% Nuxtra Zirconium | 0.1 |
| Paraffin Wax | 97.4 |

TABLE 2d

| Component | Amount (grams) |
|---|---|
| Orasol red B | 2.0 |
| Araldite GT 6084 | 8.0 |
| 6% Nuxtra Zirconium | 2.0 |
| Paraffin Wax | 88.0 |

Wherein the components may be defined as follows:
Tintacarb 300 is a carbon black C1 Pigment Blank 7 available from Cabot Corporation, Boston, Mass.;
Irgalite Blue LGLD is a pigment blue 15:3 available from Ciba Geigy, Toms River, N.J.;
Orasol red B is a red shade dye available from Ciba Geigy;
Araldite GT 6084 is an epoxy resin available from Ciba Geigy;
FOA-2 is a petroleum additive available from E.I. du Pont de Nemours and Company, Wilmington, Del.;
DC 344 is a silicone fluid available from Dow Corning, Midland, Mich.;
DC 200 Fluid is a silicone oil available from Dow Coming;
6% Nuxtra Zirconium is a solution of zirconium octoanate in white spirits available from Huls America, Inc., Somerset, N.J.; and
Paraffin Wax is a hydrocarbon wax with a melting point of 65° C. and viscosity of 3.5 mPa.s at 130° C. available from Shell Chemical, Houston, Tex.

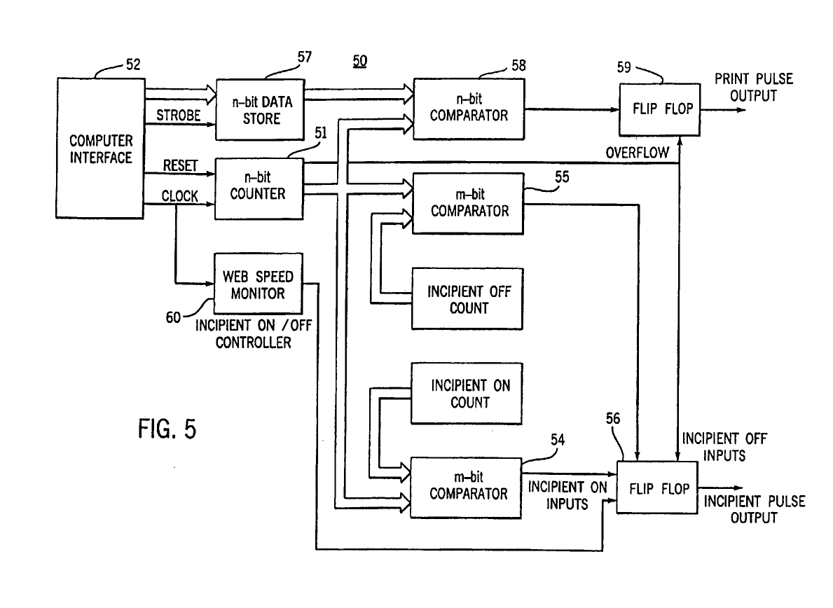

In use, the image-forming materials may be loaded into the ink-jet systems previously described. The substrate may then be directed into the ink-jet system and the image-forming material may then be imagewise deposited onto the substrate to form a relief image. As reported above, the ink-jet system and the image-forming materials are optimized to form the desired relief image, and thus, the ink-jet system may be directed to imagewise apply multiple layers of the image-forming material in order to form the relief image. Computer systems known to those of skill in the art may be utilized to direct or instruct the ink-jet system to eject the image-forming material in the desired image. FIG. 5 illustrates that an incipient drive controller 50 provides a means for generating and applying the voltage waveforms A and B. In order to obtain reliable synchronization of the two waveforms, the time period T of one print cycle is divided into equal time segments. The number of these segments is determined by the resolution or number of gray-scales required.

The print cycle is started by a computer 52 issuing a reset signal which sets the segment number to 0 and starts the segment counter 51 which is incremented by a clock signal from the computer 52. This clock signal may be either a constant frequency or a variable frequency related to the printing speed required, which for example may be determined by the speed of the substrate 136 in relation to the cell 120.

The oscillating voltage (waveform A) is generated by an incipient drive pulse on comparator 54 and an incipient drive pulse off comparator 55. Each comparator 54,55 compares the number of time segments that have passed with a desired number of segments after which the flip-flop 56 should be activated. The output of the flip-flop 56 creates the oscillating voltage output.

The start time of an ejection voltage pulse occurs after a variable number “x” of time segments has passed. The variable x, which is stored in an image data store 57, depends upon the length of ejection voltage pulse required and the number of time segments in time T of the print cycle. According to x and the number of time segments counted by the segment counter 51, the comparator 58 outputs a signal to a flip-flop 59 which, in turn, initiates an ejection voltage pulse.

When time “T” has elapsed the segment counter reaches a maximum segment count for the print cycle and outputs an overflow signal to both flip-flops 56 and 59, ensuring that both the ejection voltage pulse and the incipient drive pulse end at the same time.

It should be noted that the substrate speed monitor 60 may also be used to control the oscillating voltage. It should also be appreciated that in an array of printhead cells, individual cells may be individually applied with the ejection (as required) and incipient voltages to enable pixel by pixel printing in a drop-on-demand manner.

The height of the relief image may be defined as the distance from the surface of the substrate to the top surface of the relief image, or the droplet of image-forming material in some instances. This height may vary depending upon the application of the relief image and/or the type of printing plate desired. For a relief printing plate such as a flexographic printing plate, for example, the relief image may be from about 20 to 250 mils (500 to 6400 μm) or greater in height. Alternatively, the relief image may be from about 20 to 100 mils (500 to 2500 μm) or greater in height. In another embodiment, the height of the relief image may be about 6 to 20 mils (150 to 500 μm).

In certain embodiments, the ink-jet applied image-forming material may be treated during or after deposition onto the substrate to form the desired relief image. In one embodiment, the treatment may include drying and/or curing of the relief image to remove any excess carrier or to cause hardening or crosslinking of the image-forming material.

In one embodiment, the relief image may be dried in a forced air or infrared oven. Drying times and temperatures may vary. Suitable temperatures for oven drying may include, for example, about 60° C. In another embodiment, for example, after one or more layers of image-forming material are deposited, the intermediate relief image may be subjected to drying or curing by air, heat, ultraviolet radiation, infrared radiation and/or visible radiation before applying additional layers. U.S. Pat. No. 5,511,477 to Adler et al., which is incorporated herein by reference, reports a system in which a flexographic substrate is wrapped around a cylinder such that that the substrate may be ink-jet imaged and then radiation exposed during each rotation. Similar systems may be suitable for use in conjunction with embodiments of the present invention.

In other embodiments, the image-forming material may be capable of forming a relief image without requiring sequential ink-jet application and drying or curing steps or merely requiring a single drying or curing step. Additionally, in certain embodiments, it may be desirable to perform a back exposure or backflash step, in which ultraviolet radiation exposure occurs through the substrate to expose a portion of the image-forming material immediately adjacent to the substrate. In one embodiment of the present invention, exposing the drying or curing the image-forming material as well as exposing the image-forming material or relief image to UV radiation by back exposure, may increase adhesion of the image-forming material to the substrate.

If the image-forming material is not sufficiently oleophilic to be used in flexographic applications, the image may be further treated to increase the image's oleophilic properties. For example, in one embodiment, the relief image area may be immersed in a suitable conditioner to enhance the ink-receptive properties of at least part of the relief image area. An example of a suitable conditioner is reported in WO 90/03600, which is incorporated by reference, and is provided in Table 3 below:

TABLE 3

| Component | Amount | |
|---|---|---|
| Water | 1000 | ml |
| Ethoquad C25 | 6.0 | g |
| Phenylmercaptotetrazole | 2.8 | g |
| Cetyltrimethyl ammonium bromide | 1.5 | g |
| Sodium ferric EDTA | 40.0 | g |
| Potassium iodide | 5.5 | g |
| Potassium thiocyanate | 1.0 | g |
| Acetic acid | 20.0 | ml |

| | |
|---|---|
| Sodium acetate | quantity resulting in pH of 4.0 |

The above-reported method for forming a relief image may be used in applications in which an image or a pattern having a topography or surface texture is desired. Examples of suitable applications may include electronic parts, medical devices, and decorative materials. However, this method may be most suitable for forming relief images on flexographic plates. This method also provides for the formation of a topographical and/or relief image without undergoing the radiation exposure and/or development steps required to form conventional flexographic plates.

Although a range of components and methods have been reported herein, persons of skill in the art would be able to combine these components and methods as required by a particular application to achieve a desired result. Furthermore, combinations of two or more of the above-reported embodiments or aspects of the present invention are suitable.

In an alternative embodiment, the ink-jet systems reported herein may be used to imagewise deposit masking materials onto a photosensitive layer of a conventional flexographic printing plate precursor.

Conventional flexographic printing precursors are composed of a flexible, oftentimes transparent, substrate such as a film, a photosensitive layer, a release layer and a coversheet. After removing the coversheet and release layer, the photosensitive layer may be subjected to floodwise UV exposure through a suitable mask. The photosensitive layer may also be subjected to a back exposure or backflash step, in which ultraviolet (“UV”) exposure occurs through the substrate to expose a portion of the photosensitive material immediately adjacent to the substrate. This backflash step may improve the adhesion between the photosensitive layer and the substrate, and may also establish the depth of the relief image after development. Following exposure, the photosensitive layer may be developed with a suitable developer to form an image.

After development, the printing plate may be post-exposed to ensure that the photopolymerization process is complete. Optionally, the plate may then be subjected to detackification, a post development treatment that may be used if the surface of the photosensitive layer is still tacky. Suitable detackification processes include treatment with bromine or chlorine solutions, or with radiation exposure.

In the method of the present invention, a conventional flexographic precursor may be modified by removing the coversheet and release layer to reveal the photosensitive layer. A suitable masking material, such as the image-forming material previously described, may then be imagewise inkjet applied to the photosensitive layer and treated to form a radiation opaque image area. The photosensitive layer may then be exposed to UV radiation through the mask, as well as by back exposure to improve adhesion of the photosensitive layer to the substrate. The imaged photosensitive layer may then be developed to form an image area on the substrate. After development, the flexographic printing plate may be post-exposed and subjected to detackification as described above.

Examples of conventional flexographic printing plate precursors for use in embodiments of the present invention include Cyrel brand flexographic printing plates, available from E.I. du Pont de Nemours and Company, Wilmington, Del.

Suitable mask-forming materials should have, or may be treated to have, a sufficient optical density to protect portions of the photosensitive layer from radiation exposure. For example, the optical density of the mask material may be (or may be treated to be) greater than 2.0, more particularly greater than 2.5, even more particularly, between 2.5 and 3.0. An additional example of a suitable mask material is reported in U.S. patent application Ser. No. 10/400,959, which is incorporated herein by reference. The ink-jet applied mask-forming material may then be subjected to a suitable drying or curing step to form the mask. In certain embodiments, it may also be necessary to treat the mask by known methods to increase the optical density of the mask.

Advantageously, by utilizing the ink-jet systems reported herein, masking materials having a significant optical density may be ink-jetted onto the photosensitive layer.

After forming the mask, the flexographic printing plate precursor may be imagewise exposed to UV or visible radiation such that the portions of the photosensitive layer not protected by the mask become less developable in a conventional developer liquid than portions of the photosensitive layer that are protected by the mask. The imaged precursor may then be developed using a suitable developer liquid to remove the mask and the unexposed portions of the photosensitive layer. The resulting flexographic plate may then be used in a conventional manner.

1. A method of forming a flexographic printing plate comprising:
providing a flexible film;
providing an image-forming material including a carrier and solid particles; and
imagewise applying the image-forming material onto a surface of the film using an ink-jet system to form a relief image
wherein the ink-jet system
concentrates the marker particles to form a concentrated image-forming material having a solids content higher than about 2.4 wt %; and
deposits one or more layers of the concentrated image-forming material onto the surface of the substrate to form an image, and
wherein the image adheres to the surface of the film and resists dimensional deformation after deposition on the surface of the film to form the relief image.

2. The method of claim 1, further comprising drying or curing the relief image during or after formation of the relief image.

3. The method of claim 2, wherein the relief image is dried or cured by air, heat, ultraviolet radiation, infrared radiation or visible radiation.

4. The method of claim 2, wherein the film is sufficiently transparent to ultraviolet or infrared radiation, and the step of curing the relief image includes projecting ultraviolet or infrared radiation through the film.

5. The method of claim 2, wherein drying or curing the relief image increases adhesion of the relief image to the surface of the film.

6. The method of claim 1, further comprising treating the relief image to increase ink receptiveness of the relief image.

7. The method of claim 6, wherein treating the relief image includes exposing the relief image to a conditioner.

8. The method of claim 1, wherein the film is a polymer film, ceramic, metal, cardboard, paper, a laminate, or a combinations thereof.

9. The method of claim 1, wherein the image-forming material further comprises humectants, biocides, viscosity builders, colorants, pH adjusters, drying agents, defoamers, plasticizers, UV absorbers, IR absorbers, fillers or combinations thereof.

10. The method of claim 1, wherein the solid particles are polymeric materials, metals, ceramics, pigments, dyes, or combinations thereof.

11. The method of claim 1, wherein the ink-jet system is an electrophoretic, drop-on-demand, ink-jet system.

12. The method of claim 1, wherein the height of the relief image is about 20 to 250 mils (500 to 6400 μm).

13. The method of claim 1, wherein the height of the relief image is about 6 to 20 mils (150 to 500 μm).

14. A method of forming a mask comprising:
providing a flexible film;
providing an image-forming material including a carrier and solid particles; and
imagewise applying the image-forming material onto a surface of the film using an ink-jet system to form a relief image
wherein the ink-jet system
concentrates the marker particles to form a concentrated image-forming material having a solids content higher than about 2.4 wt %; and
deposits one or more layers of the concentrated image-forming material onto the surface of the substrate to form an image, and
wherein the image adheres to the surface of the film and resists dimensional deformation after deposition on the surface of the film to form the relief image.
